(19) United States
(12) Patent Application Publication
(10) Pub. No.: US 2003/0047291 A1
(43) Pub. Date: Mar. 13, 2003

(54) Rolling door

(76) Inventor: Arno Klein, Nordstemmen (DE)

Correspondence Address: Friedrick Kueffner, Suite 910, 317 Madison Avenue, New York, NY, 10017, US

(21) Appl. No.: 10/221,526

(22) PCT Filed: Mar. 13, 2001
(86) PCT No.: PCT/EP01/02788

(30) Foreign Application Priority Data
Mar. 13, 2000 (DE) 100 11 789.9

(51) Int. Cl. E06B 9/08

(52) U.S. Cl. 160/133

(57) ABSTRACT

The invention pertain to a roll-up gate with a gate panel which can be rolled up into a coil of several layers, the panel consisting of a plurality of solid gate battens, which extend across the width of the gate to create a rigid covering over the opening and which can move in vertical guideways. So that the gate can be opened and closed quickly and with little noise, it is provided that at least one batten has at least one support body with a pair of support elements, this pair consisting of an internal and an external support surface, the distance between which is designed so that, when the battens are rolled up, the internal support surface can rest on the external support surface of the preceding layer of the coil, while the remainder of the battens remains free.

The invention pertains to a roll-up gate with a gate panel which can be rolled up into a coil of several layers, the panel consisting of a plurality of solid gate battens, which extend across the width of the gate to create a rigid covering over the opening and which have the freedom to move preferably in approximately vertical guideways, and to a connecting element for the production of hinged connections between the individual battens of the gate panel.

Various designs of roll-up gates are known. In one embodiment, the individual battens are rolled up on a shaft directly on top of each other. This design suffers from significant disadvantages. Because the battens are simply rolled up on top of each other, abrasion marks and wear occur after only a short time. As a result, the visual appearance of the gate is impaired, and a great deal of noise is also created during the rolling process, so that gates of this type can be rolled up only at slow speed.

A roll-up gate of the general type in question is known from EP-B1 0,531,320, which avoids these disadvantages by means of a double guide in the area of the lintel. The gate panel is pressed upward into the guide. This design has the disadvantage that the drive force must be applied from underneath. Because the gate panel is pushed into a spiral-shaped guideway, the drive power for this known gate must be applied in a very complicated manner by way of the last batten at the bottom. Because of the complicated guideway, the gate produces a great deal of noise, which is also disadvantageous. In addition, the complicated design leads to reliability problems. A similar gate is described in DE 40 15 214 A1.

A roll-up steel shield is described in DE 44 39 718 A1, furthermore, in which every second bar of the roll-up shield is equipped with a clip, which prevents these bars of the roll-up shield from resting directly on a guide rail.

The task of the invention is therefore to reduce the amount of noise produced, to improve the operational reliability of the roll-up gate of the general type in question, and to avoid impairment to the external appearance of the battens.

For a roll-up gate with a gate panel which can be rolled up into a coil of several layers, the panel consisting of a plurality of solid gate battens which extend across the width of the gate to create a rigid covering over the opening and which have the freedom to move preferably in approximately vertical guideways, the task is accomplished by the elaboration of the known roll-up gates described in the characterizing clause of Claim 1. The main idea on which the invention is based is to assign a support body only to some of the individual battens. When in this case only every second batten is equipped with a support body, the support surfaces in question can extend all the way to the adjacent batten and preferably up to a point approximately half way across the width of the adjacent batten. So that the gate can be rolled up and down reliably, quietly, and uninterruptedly without the formation of excessive bulges, it has been found advisable for at least two battens directly adjacent to each other to be equipped in each case with at least one support body. To avoid damage to the battens in an especially reliable manner and to obtain an effective reduction in the noise level, each batten which ends up between two layers of the coil after the panel has been rolled up can have at least one support body, each one of which preferably has a pair of support surfaces, one external and one internal. But even in this embodiment of the invention, it is also possible without impairing the operating reliability or increasing the amount of noise produced, for certain battens, such as those which are at the bottom of the gate when it is closed and which do not end up in the coil or which form the outermost layer of the coil when the gate is open, to be designed without support bodies or with support bodies which have only an internal support surface. The battens forming the inner layer of the coil can also be designed without support bodies or be equipped with support bodies which have only an external support surface.

In most cases of an especially advantageous design of the invention, it is sufficient for the support surfaces to be located at the ends of the battens of the gate panel, preferably on connecting elements which hold the ends of the battens. Additional support surfaces are required only when the gate panel is so wide that the coil becomes unstable or when it is desired to damp flexural vibrations occurring outside the nodal points. In principle, however, the support surfaces and the connecting elements can be separate from each other. For example, the battens can be connected to each other by hinges, and the support surfaces can be provided on the battens.

It is especially easy to roll up the gate panel when the support surfaces are designed with a curvature which bends around the roll-up axis. As the radius of the coil increases, the radius of this curvature must therefore also increase accordingly. In practice, however, an intermediate radius is usually sufficient to ensure a sufficiently smooth rolling-up process, especially when a resilient, especially an elastic, damping material is applied to the support surface as well. If the support surfaces are convex on one side and concave on the other, the axis of this curvature being transverse to the direction of motion, the connecting elements can also advantageously guide the battens as they are being rolled up.

Additional joints can be advantageously avoided by connecting the battens tightly to the connecting elements, which are connected flexibly to each other to form a chain. The connecting elements with the support surfaces can, for example, be seated on, and permanently connected by suitable means to, the ends of the battens, which are designed as hollow sections. In this case, the support bodies designed as connecting elements perform a double function. First, they create a hinged connection between the individual battens; second, they prevent the battens in adjacent layers of the coil from colliding with each other when in the rolled-up state.

It is then sufficient for only the connecting elements to have guide elements such as guide rollers to guide the movement of the gate panel and preferably for the connecting elements to be connected to each other by joints to form a chain.

Because two adjacent battens have a common swivel axis, which is designed to be in alignment with the axis of the chain joints and preferably with the axis of the guide rollers, the common swivel axis exists only as a design feature and not physically. The common swivel axis is formed by the joint axis of the connecting elements.

In another advantageous embodiment of the invention, at least one roll-up pulley is provided on a vertical plane at the horizontal location of the pairs of support surfaces. This pulley has a spiral-shaped circumferential surface, the lead of the spiral being calculated so that it corresponds to the distance between the support surfaces of a support surface pair. The top end of the chain supporting the gate panel is attached to the shoulder of the roll-up pulley formed by the lead. In this way, a nearly continuous surface is formed for the roll-up process onto which the chain can be rolled, which means that no jolts are produced. Such jolts have the effect of producing high noise levels and mechanical stress on the gate structure, which are disadvantageous over extended periods of time.

The power of the drive unit can be advantageously reduced by providing a device with a tension spring to compensate for the weight of the unrolled part of the gate panel.

The same purpose is served by providing at least one device which can produce a force to assist with the acceleration and deceleration of the gate panel. In the case of wide gates, it is advantageous to install these devices as a pair, one at each end of the coil, to avoid disadvantageous torsional forces on the coil. A weight can be used to produce this force.

The need for separate devices for assisting the deceleration and the acceleration of the gate panel can be advantageously avoided by allowing the force, such as the equilibrium force, to change the direction in which it acts during the opening and closing of the gate panel.

The entry of the gate panel into and its departure from the vertical guideways is facilitated advantageously by setting up roll-up axis in such a way that the distance between it and the vertical guide plane formed by the guideways changes to correspond to the changing radius of the coil. This distance therefore changes automatically during the roll-up process. As a result, the gate panel will always pass tangentially from the coil into the guideways and back out of them again without jolting.

It is advantageous for the distance to be adjusted positively by the use of gears to derive the power used to shift the roll-up shaft from the drive used to roll up the panel. A mechanism in which the roll-up shaft is at a fixed distance from a gear wheel, which engages with a chain under linear tension, is both simple in design and advantageously reliable in operation. The chain can be a standard commercial bicycle chain, for example, used in conjunction with an appropriate pinion.

Damage to the guides and to the gate panel as well as dangerous accidents involving the operation of vehicles can be reduced by designing the guideways with the ability to give way when a certain force acting transversely to the plane of the gate panel is exceeded. If a vehicle cannot stop in time in front of the gate, the guideways will release the gate during the subsequent impact, and the gate will give way.

The invention is explained below on the basis of a drawing of a preferred exemplary embodiment:

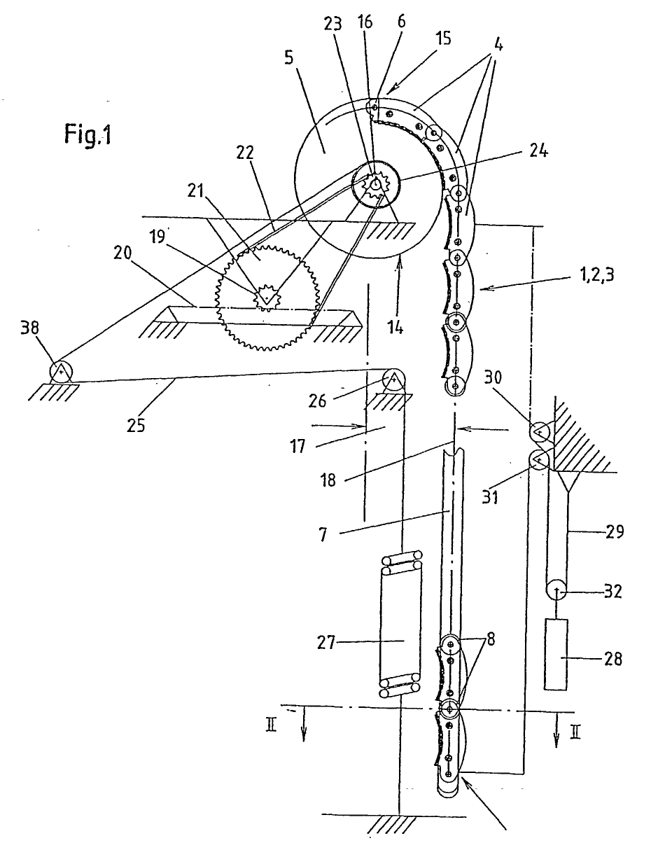

FIG. 1 shows a schematic side view of the roll-up gate according to the invention;

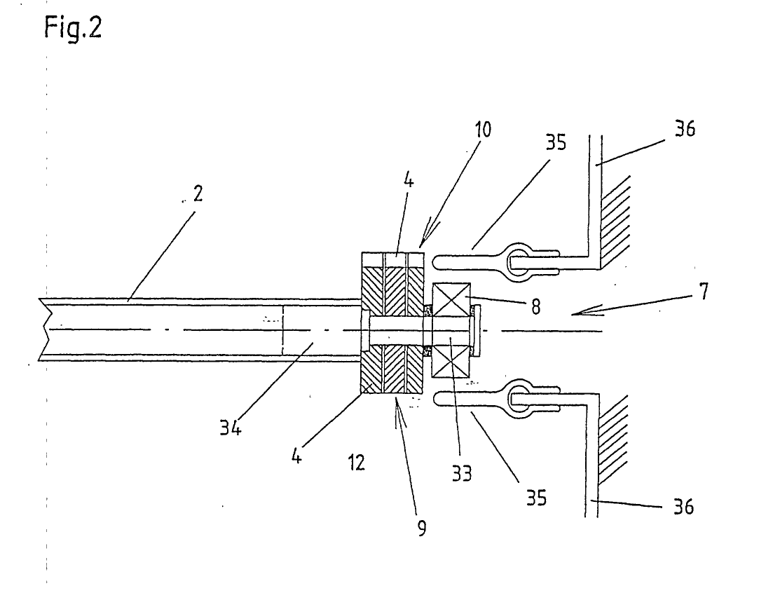

FIG. 2 shows a cross section through a side guideway along cross-sectional line II-II in FIG. 1;

FIG. 3 shows a side view of two adjacent gate panel battens in the rolled-up state;

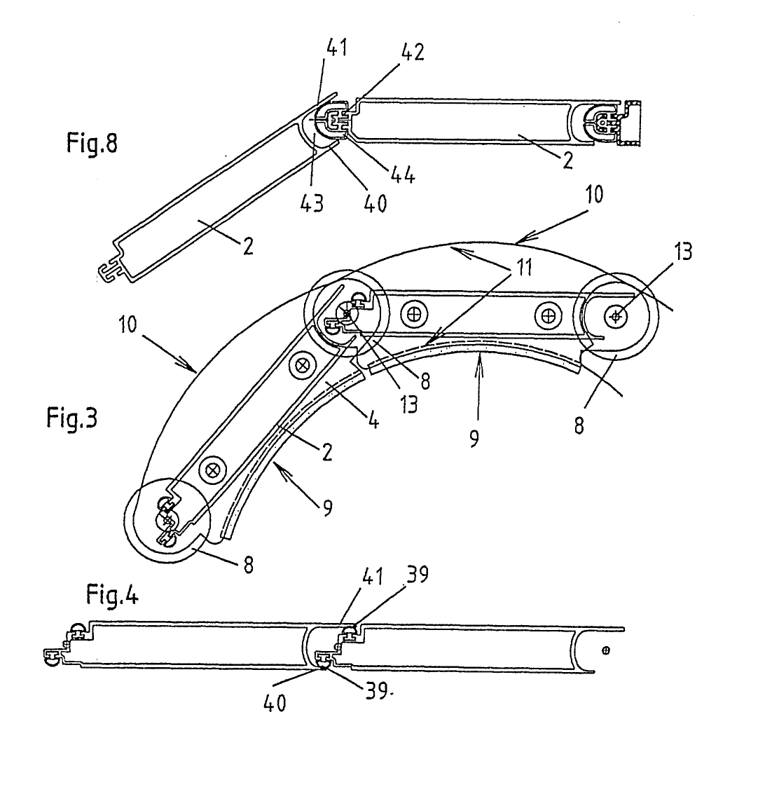

FIG. 4 shows a side view of two adjacent gate panel battens in the unrolled state;

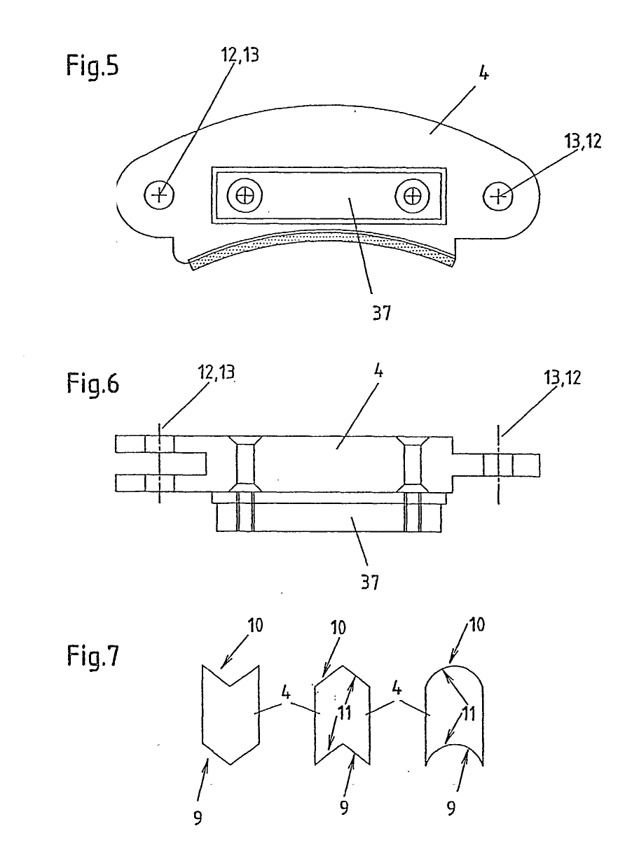

FIG. 5 shows a side view of the connecting element;

FIG. 6 shows a top view of the connecting element according to FIG. 5;

FIG. 7 shows three different shapes of the support surfaces; and

FIG. 8 shows a side view of an alternative embodiment of two adjacent gate panel battens.

FIG. 1 shows a side view of the roll-up gate according to the invention in schematic fashion. It consists of a plurality of battens 2 (FIG. 3), arranged in a row in the vertical direction. The battens extend horizontally over the entire width of the gate and thus form the gate panel 3. At their ends, the battens are rigidly connected to connecting elements 4. The connecting elements 4 cooperate with each other to form a chain, the end of which is attached by a bolt 6 to a wind-up pulley 5.

To the right and to the left of the gate panel 3, the guideways 7 are provided, in which the connecting elements 2 are guided essentially vertically and horizontally by the guide rollers 8, which are attached to the connecting elements.

In the case of the embodiment of the invention shown in the drawing, each connecting element 4 (FIGS. 3, 5, 6, and 7) has an internal support surface 9 and an external support surface 10, which represent a pair 11 of curved support surfaces, the distance between the two surfaces being calculated so that, when in the rolled-up state, the profiles of the battens 2 find room between the two surfaces but do not come in contact with each other. As shown in FIG. 7, giving the support surfaces the proper concave and convex shape by which they can guide themselves, they have a self-adjusting effect which forces the battens to be rolled up in parallel fashion. This has an advantageous effect on the smooth operation of the roll-up gate. The connecting elements 4 have mounting plugs 37 (FIGS. 5 and 6), which are adapted to conform to the internal shape of the battens. The battens are seated on these plugs and fastened to them.

In the example shown, the joint axis 12 of the connecting element 4 (FIG. 2) is aligned with the design swivel axis 13 of the batten. The axis of the guide roller 8 is also aligned in the same way. This aspect of the design is not mandatory, however. The rollers, for example, could also be located in the middle between the swivel axes 12, or several rollers can be provided here.

The roll-up pulley 5 has a spiral outer circumferential surface 14, so that a shoulder 15 is formed. The height of the shoulder preferably corresponds approximately to the distance between the two support surfaces of the pair 11, so that, when the panel is rolled up, the external support surfaces 10 of the connecting elements 4 can form a continuation of the circumferential surface of the pulley. After a complete revolution of the roll-up pulley 5, the internal support surfaces 9 make contact with the external support surfaces 10 of the previous turn. Because of the distance between the support surfaces, however, the battens do not touch, so that there are no jolts or collisions.

The center of rotation of the roll-up pulley 5 and the main shaft determine a roll-up axis 16, the distance 17 of which from the plane 18 of the gate panel, which is determined by the guideways, is designed to be variable, in that the bearings of the main shaft 16 can be shifted in the horizontal direction. The bearing of a gear wheel 19, which engages in a stationary, horizontally stretched chain 20, is fixedly to the bearing of the roll-up shaft 16. Another gear wheel 21 is connected nonrotatably to the gear wheel 19; an endless chain 22 passes around this other gear wheel. The chain is driven by a pinion of the drive unit (not shown) for the roll-up shaft or, as illustrated here, directly by a pinion 23 connected to the roll-up shaft. The reduction ratio is selected so that one revolution of the roll-up shaft during the roll-up process increases the distance between the shaft and the plane 18 of the gate panel by an amount equal to the distance between the support surfaces; as a result, the plane 18 of the gate panel remains at a tangent to the current radius of the rolled-up panel.

To compensate for the weight of the panel which is not rolled up, a winding drum 24 is mounted nonrotatably on the roll-up shaft; a belt 25 is attached to this drum, the other end of which is attached by way of guide pulleys 38, 26 to a tension spring 27. The spring characteristic of the tension spring 27 and the diameter of the winding drum 24 are coordinated in such a way that the weight of the gate panel at any one time is almost perfectly compensated. The winding direction is set up so that the belt unwinds as the gate panel is rolled up. The tension spring thus becomes shorter, a process which is reinforced by the decrease in the distance between the roll-up shaft 16 and the guide pulley 38, so that the tensile force of the spring decreases correspondingly. The weight of the as-yet unrolled gate panel decreases similarly.

Because roll-up gates of this type are often supposed to be rolled up and down as quickly as possible, considerable forces of acceleration or deceleration can develop, which the drive must be designed to accommodate. To assist the drive, a device is therefore provided which consists of a weight 28, the force of which acts at the bottom end of the gate panel and is guided by a belt 29, by an upper guide pulley 30, by a lower guide pulley 31, and by a block 32. One end of the belt 29 is attached permanently above the weight 28, the other end to the gate panel. Proceeding from its stationary end, the belt 29 first forms an arc around the block 32, on which the weight 28 acts. Then the belt is guided between the guide pulleys 30, 31, which are permanently installed at approximately ¾ of the height of the gate panel, and passes onward to the bottom end of the gate panel. As long as the end of the gate panel is below the guide pulley 31, the force of the belt 29 acts upward and thus has an accelerating effect on the process of opening the gate or helps to decelerate the process of closing the panel. As soon as the attachment point of the belt 29 is above the height of the pulley 31, the force of the belt pulls downward, so that the process of opening the panel is decelerated. This situation is shown by the belt indicated in broken line in FIG. 1.

A spring, especially a tension or torsion spring, which is attached to the belt 29, can be used instead of a weight.

FIG. 2 shows a cross section through the guideway 7. Two adjacent connecting elements 4 are connected by a swivel pin 33, which simultaneously forms the bearing axis for the guide roller 8, which is attached axially by suitable means. On the connecting element 4, a plug 34 is provided, which is inserted into the open end of the hollow section of the batten 2 to seal it. The guide rollers 8 run between guide strips 35, which are molded of plastic, and which extend outward to form two parallel sidepieces, which form a clamping gap between them. These sidepieces are then seated on the free sidepieces of two angle sections 36 of metal. As soon as the guide rollers 8 exert too much force on the guide strips 35, the strips can give way, preferably in elastic fashion, and thus release the gate panel. The transition to the clamping gap forms a predetermined flex point for the guide strips.

FIG. 3 shows two adjacent battens with their assigned connecting elements in the rolled-up position, whereas FIG. 4 shows how the battens form a gate panel in the unrolled position.

Because of the special design of the battens, the sealing lip provided on one side of each batten come to rest against a corresponding, mating surface of the adjacent profile. The gate panel is thus especially leak-tight and mechanically sturdy.

FIG. 8 shows an alternative design of the seal between two adjacent battens. A strip 42 is formed along one of the long sides of the batten; this strip engages in the groove 43 formed by a shorter, inner web 40 and a longer, outer web 41. Because of the different lengths of the webs 40, 41, the battens 2 can swivel with respect to each other. A plastic section 44 forms a U-shaped enclosure around the strip 42 and thus prevents the battens from touching each other directly no matter how far they are tilted. This prevents noise from being generated; an effective seal is achieved; and a sliding, articulated connection is realized.

In this way a roll-up gate is created which produces minimal noise even though it can still be opened and closed very quickly. As a result of the surprisingly simple design, it also is highly resistant to operational difficulties.

1. Roll-up gate with a gate panel which can be rolled up into a coil of several layers, the panel consisting of a plurality of solid gate battens, which extend across the width of the gate to create a rigid covering over the opening and which have the freedom to move preferably in approximately vertical guideways, characterized in that at least one support body with an interior or exterior support surface, preferably with a pair (11) of support surfaces, is assigned to at least one batten, preferably to at least two battens adjacent to each other, and even more preferably to each batten (2) located between two layers of the panel after it has been rolled up, which pair of support surfaces (11) is formed by an internal support surface (9) and an external support surface (10), the distance between them being selected so that, in the rolled-up state of the battens, the internal support surface (9) rests on the previous turn of the coil, preferably on an external support surface (10) of a support body of the previous turn of the coil, and/or the external support surface of the previous turn of the coil rests on the current turn of the coil, preferably on an internal support surface of a support body of this current turn of the coil, whereas the remainder of the battens (2) remains free.

2. Roll-up gate according to claim 1, characterized in that the support surfaces (9, 10) are provided at the ends of the battens (2) of the gate panel (3), preferably on connecting elements (4), which support the ends of the battens (2) and form the support bodies.

3. Roll-up gate according to claim 2, characterized in that the connecting elements are hinged to each other to form a chain.

4. Roll-up gate according to claims 1-3, characterized in that the support surfaces (9, 10) are designed with a curvature which bends around the roll-up axis (16) and/or are convex on one side and concave on the other side transversely to the direction of motion.

5. Roll-up gate according to one of the preceding claims, characterized in that the battens (9) are rigidly connected to the connecting elements (4).

6. Roll-up gate according to one of the preceding claims, characterized in that the connecting elements (4) have at least one guide element such as a guide roller (8).

7. Roll-up gate according to one of the preceding claims, characterized in that two adjacent battens (2) have a common swivel axis (13), which is aligned with the axis (12) of the chain joints and preferably also with the axis of the guide rollers (8).

8. Roll-up gate according to one of the preceding claims, characterized in that at least one wind-up pulley (5) is provided in the vertical plane at the horizontal location of the pair (11) of support surfaces, which pulley has a spiral-shaped circumferential surface (14), the lead of the spiral being calculated so that it corresponds to the distance between the two support surfaces of a support surface pair (11).

9. Roll-up gate according to one of the preceding claims, characterized in that a device with a tension spring (27) is provided to compensate for the weight of the part of the gate which has not been rolled up.

10. Roll-up gate according to one of the preceding claims, characterized in that a device with a weight (28) is provided, the force of which is designed to assist with the acceleration and deceleration of the gate panel.

11. Gate, especially a roll-up gate according to one of the preceding claims, with a device which exerts a force on the gate panel to assist with the acceleration and deceleration of the gate panel, characterized in that the direction in which the force acts changes during the opening or closing of the gate panel.

12. Roll-up gate according to claim 11, characterized in that the device has a weight and/or a spring, especially a tension spring, to produce the force.

13. Roll-up gate according to claim 12, characterized in that the weight and/or the spring is connected by tension means such as a chain or belt to the gate panel, where the tension means passes around a first guide element in a first phase of the movement of the gate panel and passes around a second guide element in a second phase of the movement of the gate panel.

14. Roll-up gate according to one of the preceding claims, characterized in that the roll-up axis (16) is separated from the vertical guide plane (18) formed by the guideways by a distance (17) which corresponding to the current radius of the coil.

15. Roll-up gate according to one of the preceding claims, characterized in that the roll-up shaft (16) is a fixed distance away from a gear wheel (19), which is set up to engage in a chain (20) subjected to linear tension.

16. Roll-up gate according to one of the preceding claims, characterized in that a sealing element, preferably formed as a plastic section, is located between two adjacent battens (2).

17. Roll-up gate, especially according to one of the preceding claims, with a gate panel which is free to move along vertical guideways, characterized in that the guideways (7) are designed to give way when a certain force acting transversely to the plane of the gate panel is exceeded.

18. Connecting element for a roll-up gate according to one of claims 2-17.
